(19) United States
(12) Patent Application Publication
(10) Pub. No.: US 2007/0291002 A1
(43) Pub. Date: Dec. 20, 2007

(54) LASER MOUSE AND CONTROL METHOD THEREOF

(75) Inventors: Liang-Yu Yao, Taipei County (TW); Wei-Chan Sung, Taichung City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: DARFON ELECTRONICS CORP., Taoyuan (TW)

(21) Appl. No.: 11/755,856

(22) Filed: May 31, 2007

(30) Foreign Application Priority Data
Jun. 16, 2006 (TW) 95121585

(51) Int. Cl. G09G 5/08

(52) U.S. Cl. 345/166

(57) ABSTRACT

A method for controlling a laser mouse on a surface is provided. The laser mouse includes a laser mouse control unit, a light transmitter and a light receiver. The laser mouse control unit radiates a beam of laser light and detects a moving position of the laser mouse relative to the surface according to a part of the laser light reflected from the surface. The light transmitter generates a beam of light, and the light receiver receives a part of the light reflected from the surface and accordingly generates a signal. The method includes setting a threshold value according to the signal; and determining whether the intensity of the signal is smaller than the threshold value, and if yes, controlling the laser mouse control unit to stop radiating the laser light.

This application claims the benefit of Taiwan application Serial No. 095121585, filed Jun. 16, 2006, the subject matter of which is incorporated herein by reference.

### BACKGROUND OF THE INVENTION

1. Field of the Invention

The invention relates in general to a laser mouse and control method thereof, and more particularly to a laser mouse, which can stop radiating laser light within a specific height range relative to any usage surface, and control method thereof.

2. Description of the Related Art

Recently, laser light, a kind of coherence light, has been applied in a laser mouse due to having better optical identification effect. The laser mouse illuminates a usage surface by laser light. The laser light reflected from the surface generates fine and regular interference fringes or speckle patterns on a light sensing device of the laser mouse according to variation of roughness of the illuminated surface and a moving position of the laser mouse relative to the surface can then be detected according to the interference fringes and speckle patterns.

However, in the present laser radiation operation, whether the laser mouse enters a sleep mode is determined according to length of rest time of the laser mouse or the intensity of the laser light is adjusted according to an operational mode of a computer. Therefore, the user may directly look at the laser light of high energy without care as lifting the laser mouse, thereby hurting his/her eyes.

### SUMMARY OF THE INVENTION

The invention is directed to a laser mouse and control method thereof. As applied to different surfaces, the laser mouse can stop radiating the laser light at a specific height range to prevent the user from directly looking at the laser light and reduce power consumption.

According to a first aspect of the present invention, a laser mouse used on a surface is provided. The laser mouse comprises a laser mouse control unit, a light transmitter, a light receiver and a processing unit. The laser mouse control unit is for radiating a beam of laser light and detecting a moving position of the laser mouse relative to the surface according to a part of the laser light reflected from the surface. The light transmitter is for generating a beam of light. The light receiver is for receiving a part of the light reflected from the surface and accordingly generating a signal. The processing unit is electrically coupled to the light receiver and the laser mouse control unit. The processing unit sets a threshold value according to the signal under a threshold-value setting mode and when the processing unit determines intensity of the signal is smaller than the threshold value under a normal operation mode, the processing unit controls the laser mouse control unit to stop radiating the laser light.

According to a second aspect of the present invention, a method for controlling a laser mouse on a surface is provided. The laser mouse comprises a laser mouse control unit, a light transmitter and a light receiver. The laser mouse control unit radiates a beam of laser light and detects a moving position of the laser mouse relative to the surface according to a part of the laser light reflected from the surface. The light transmitter generates a beam of light, and the light receiver receives a part of the light reflected from the surface and accordingly generates a signal. The method comprises setting a threshold value according to the signal; and determining whether intensity of the signal is smaller than the threshold value, and if yes, controlling the laser mouse control unit to stop radiating the laser light.

The invention will become apparent from the following detailed description of the preferred but non-limiting embodiments. The following description is made with reference to the accompanying drawings.

### BRIEF DESCRIPTION OF THE DRAWINGS

FIG.1 is a schematic partial diagram of the laser mouse according to the invention.

FIG. 2 is a flow chart of a method for controlling the laser mouse according to the invention.

FIG. 3A is a diagram of relation curves between the intensity of signal of the light receiver in FIG. 1 and the height of the laser mouse located on surfaces of different materials.

FIG. 3B is a diagram of the corresponding curves in FIG. 3A with the electric current equal to 1 as the height of the laser mouse is 0.

FIG. 4 is a timing diagram of the switching between the threshold-value setting mode and the normal operation mode of the processing unit according to the first example of the invention.

### DETAILED DESCRIPTION OF THE INVENTION

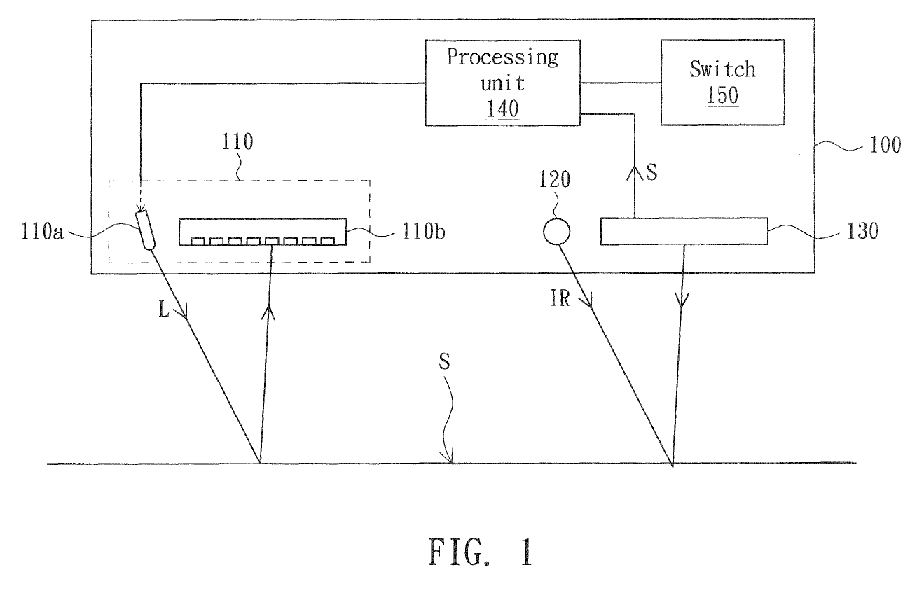

Referring to FIG.1, a schematic partial diagram of the laser mouse according to the invention is shown. A laser mouse 100, used on a surface S, includes a laser mouse control unit 110, light transmitter 120, light receiver 130 and processing unit 140. In FIG. 1, the laser mouse 100 further includes a switch 150. The processing unit 140 is electrically coupled to the light receiver 130 and laser mouse control unit 110. The switch 150 is electrically coupled to the processing unit 140.

As shown in FIG. 1, the laser control unit 110 includes a laser source 110a and a laser sensing device 110b. For example, the laser source 110a is a laser diode and the laser sensing device 110b is a charge couple device (CCD) or a complementary metal oxide semiconductor (CMOS) light sensing device. The light transmitter 120 is a light emitting diode (LED) and the light receiver 130 is a photo-transistor or photo diode.

The laser source 110a of the laser control unit 110 is for radiating a beam of laser light L to illuminate the surface S. A part of the laser light L reflected from the surface S forms a speckle pattern on the laser sensing device 110b according to an interference principle. Accordingly, the laser sensing device 110b detects a moving position of the laser mouse 100 relative to the surface S. The light transmitter 120 is also for generating a beam of light IR, such as infrared light, to illuminate the surface S and the light receiver 130 is for receiving a part of the light IR reflected from the surface S and accordingly generating a signal S. In the following description, it is exemplified that the signal S generated by the light receiver 130 is an electric current signal and the intensity of the signal S is the magnitude of the electric current.

According to a design of the invention, the processing unit 140 controls a laser radiation operation of the laser source 110a in the laser mouse control unit 110 according to the signal S generated by the light receiver 130. The related control method is illustrated in details as follows with reference to the accompanying drawings.

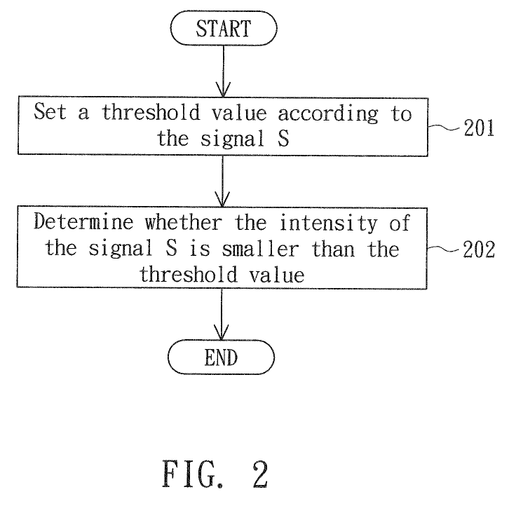

Referring to FIG. 2, a flow chart of a method for controlling the laser mouse 100 according to the invention is shown. First, in step 201, a threshold value is set according to the signal S. At the time, the processing unit 140 is under a threshold-value setting mode. For example, the processing unit 140 can be controlled to enter the threshold-value setting mode by the user triggering the switch 150. Or the processing unit 140 is designed to automatically enter the threshold-value setting mode at a constant period (described in detailed as below).

Then, in step 202, it is determined whether the intensity of the signal S is smaller than the threshold value. If yes, the laser mouse control unit 110 is controlled to stop radiating the laser light. At the time, the processing unit 140 is under a normal operation mode. When the intensity of the signal S, such as the magnitude of the electric current, is lower than the threshold value (because the user lifts the laser mouse 100 to a specific height such that the intensity of the light signal received by the light receiver 130 is reduced and the intensity of the signal S is reduced accordingly), the determination operation can prevent the user from directly looking at the laser light of the laser source 110a as lifting the laser mouse 100.

Two examples are given to concretely illustrate how the threshold value is set and the determination operation is performed in the steps 201 and 202.

### EXAMPLE ONE

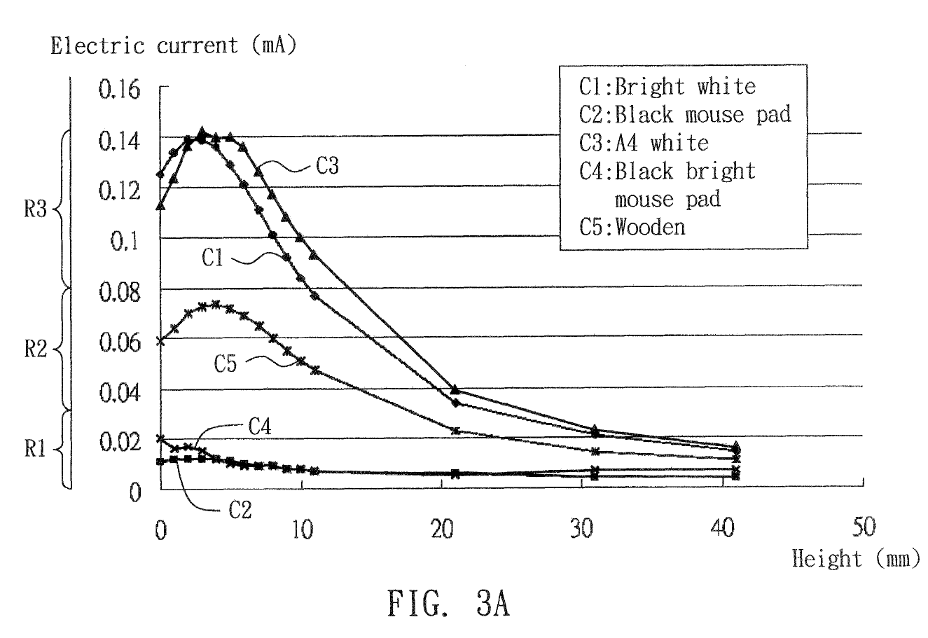

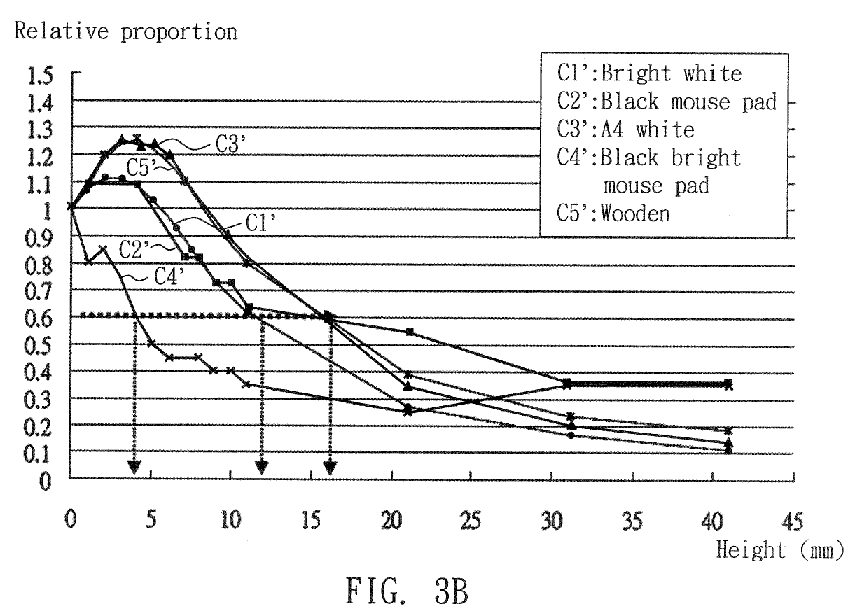

FIG. 3A is a diagram of relation curves between the intensity of signal S of the light receiver 130 in FIG. 1 and the height of the laser mouse 100 located on surfaces of different materials. FIG. 3B is a diagram of the corresponding curves in FIG. 3A with the electric current equal to 1 as the height of the laser mouse 100 is 0. Referring to FIGS. 3A and 3B, as mentioned above, the light receiver 130 generates an electric current signal for instance. The vertical axis of FIG. 3A represents magnitude of the electric current and the transverse axis of FIG. 3A represents the height of the laser mouse 100. In FIG. 3A, five kinds of surfaces S are listed and the corresponding curves are C1˜C5. It can be seen that the electric current is inversely proportional to the height of the laser mouse 100 roughly. At the position near the surface S, when the light transmitter 120, the light receiver 130 or other component has a proper relative configuration position in the laser mouse 100, the electric current may be directly proportional to the height of the laser mouse 100.

Besides, in FIG. 3B, curves C1′˜C5′ respectively represents the curves C1˜C5 of FIG. 3A with the electric current equal to 1 as the height of the laser mouse 100 is 0. The variation of the curves C1′˜C5′ can be seen to have consistency. The threshold value is set accordingly (described in details as below).

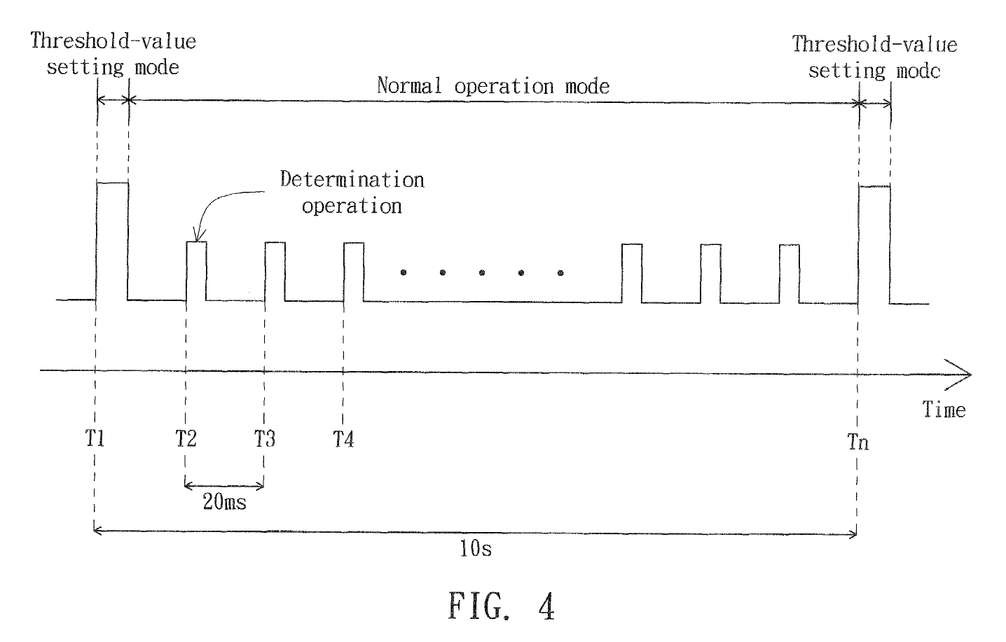

Referring to FIG. 4, a timing diagram of the switching between the threshold-value setting mode and the normal operation mode of the processing unit 140 according to the first example of the invention is shown. In the first example, in addition that the processing unit 140 is controlled to switch to the threshold-value setting mode by triggering the switch 150, the processing unit 140 can be designed to enter the threshold-value setting mode once again every a first period, such as 10 sec and enter the normal operation mode after a processing time. Under the normal operation mode, the processing unit 140 determines whether the intensity of the signal is smaller than the threshold value every a second period, such as 20 ms as shown in FIG. 4.

In normal applications, the laser mouse 100 directly contacts the surface most of time. Therefore, it can be supposed the laser mouse 100 contacts the surface (at the height 0) at the time point T1. Or at the time point T1, the laser mouse 100 has a height 0 and the user triggers the switch 150. At the time, as shown in FIG. 4, the processing unit 140 enters the threshold-value setting mode. Take the laser mouse 100 operated on the wooden material as an example, and the processing unit 140 can read the electric current to be 0.06 mA as shown in the curve C5 of FIG. 3A.

Moreover, it can be known from FIG. 3A that the surface with better reflection effect needs a higher threshold value obviously in order that the laser mouse 100 can stop radiating laser light at a specific height relative to the surfaces of various materials. In the first example, the threshold value is substantially and directly proportional to the intensity of the signal S as the processing unit 140 is under the threshold-value setting mode. At the time, in step 201, a preset value larger than 0 and smaller than 1 is provided and the threshold value is set to be a multiplication of the intensity of the signal S and the preset value as the processing unit 140 is under the threshold-value setting mode. The preset value can be determined according to the usage environment and the applied light transmitter 120 and light receiver 130. For example, from the curve C5′ of FIG. 3B, if the laser mouse 100 is designed to stop radiating laser light at a height 16 mm relative to a surface of wooden material, the preset value can be set to be 0.6 and the threshold value is 0.036(=0.06×0.6).

Following that, as shown in FIG. 4, when the processing unit 140 enters the normal operation mode, and the determination operation in the step 202 is performed at the time point T2, as soon as the processing unit 140 reads the electric current generated by the light receiver 130 to be smaller than 0.036 mA, it stops radiating the laser light. In this way, the laser mouse 100 has no danger as lifted beyond a specific height, such as 16 mm. When the electric current is determined to be larger than 0.036 mA at a time point T3, the laser source 110a can recover to radiate laser light. However, if the electric current is still smaller than 0.036 mA at the time point T3, the radiation of laser light is still stopped.

Similarly, when the laser mouse 100 is applied to other surface material, the threshold value can also be obtained by the above method. As shown in FIG. 3B, when the same setting method is applied to other surface material with the same electric current corresponding to the height 0 of the laser mouse 100 and the same preset value (such as 0.6) as the above wooden surface material, the height of the laser mouse 100 to stop radiating laser light can be controlled within a suitable range (such as 4˜16 mm).

### EXAMPLE TWO

The second example is different from the first example in the threshold value setting method of the step 201. As shown in FIG. 3A, different surface material has different reflection features, which results in great variation of the electric current corresponding to the height 0 of the laser mouse 100. At the time, the vertical axis of FIG. 3A can be suitably divided into a number of intensity ranges R1˜R3 and a corresponding selection value is preset for each intensity range. For example, the intensity range R2 including 0.06 mA can have the corresponding selection value 0.036.

In the second example, the processing unit 140 is designed to store a look-up table including the intensity ranges R1˜R3 and the corresponding selection values. For example, after the processing unit 140 enters the threshold-value setting mode at the time point T2 of FIG. 4, it selects one of the intensity range R1˜R3 according to the electric current of the height 0, and then sets the corresponding selection value to be the threshold value according to the look-up table. Therefore, when the laser mouse 100 is applied to other kind of surface similar to the wooden material, and the selection value 0.036 is used to be the threshold value, the laser mouse 100 can also stop radiating laser light at a similar height, such as 16 mm without need to calculate again the multiplication of the electric current and the preset value as in the first example. By doing this, the operation loading of the processing unit 140 can be obviously reduced.

Of course, any one skilled in the scope of the invention will realize the invention is not limited to the above two examples. First, in the first example, the threshold value is not necessary to be set by multiplying the electric current with a constant preset value, and can be also set by a non-linear direct proportional method. For example, from FIG. 3B, as for the surface with a poor reflection effect, such as a black bright mouse pad (the curve C4′), if the preset value for setting the threshold value is smaller than 0.6, such as 0.4, obviously, the height range of the laser mouse 100 to stop radiating laser light can be further reduced to 10˜16 mm.

Besides, when the look-up table is applied in the second example, according to hardware ability and users' requirements, the number or accuracy of the intensity ranges can both be adjusted. Moreover, it depends which signal the light receiver converts the light signal into, and a voltage of the signal can also be used for setting the threshold value. In addition to continuously emitting light, the light transmitter can also periodically generate light in accordance with the first period and the second period in order to save power. As long as no matter with surface material is applied, the purpose of stopping the laser mouse from radiating laser light within a specific height range can be achieved, any alternative will not depart from the scope of the invention.

In the laser mouse and control method disclosed by the above two examples of the invention, no matter what surface the laser mouse is used to, the laser mouse can stop radiating laser light within a specific height range to prevent the user from looking at the laser light directly and reduce power consumption.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A laser mouse, used on a surface, comprising:
a laser mouse control unit, for radiating a beam of laser light and detecting a moving position of the laser mouse relative to the surface according to a part of the laser light reflected from the surface;
a light transmitter, for generating a beam of light;
a light receiver, for receiving a part of the light reflected from the surface and accordingly generating a signal; and
a processing unit, electrically coupled to the light receiver and the laser mouse control unit, wherein the processing unit sets a threshold value according to the signal under a threshold-value setting mode and when the processing unit determines intensity of the signal is smaller than the threshold value under a normal operation mode, the processing unit controls the laser mouse control unit to stop radiating the laser light.

2. The laser mouse according to claim 1, wherein the threshold value is substantially and directly proportional to the intensity of the signal as the processing unit is under the threshold-value setting mode.

3. The laser mouse according to claim 2, wherein the threshold value is substantially equal to a multiplication of the intensity of the signal and a preset value, and the preset value is larger than 0 and smaller than 1.

4. The laser mouse according to claim 3, wherein the preset value is substantially equal to 0.6.

5. The laser mouse according to claim 2, wherein the processing unit stores a look-up table comprising a plurality of intensity ranges and selection values, the processing unit selects one from the intensity ranges according to the intensity of the signal under the threshold-value setting mode and sets the selection value corresponding to the selected intensity range to be the threshold value according to the look-up table.

6. The laser mouse according to claim 1, wherein the processing unit enters the threshold-value setting mode once again every a first period.

7. The laser mouse according to claim 6, wherein the first period is about 10 seconds.

8. The laser mouse according to claim 1, further comprising a switch electrically coupled to the processing unit, wherein when the switch is triggered, the processing unit enters the threshold-value setting mode once again.

9. The laser mouse according to claim 1, wherein the processing unit determines whether the intensity of the signal is smaller than the threshold value every a second period under the normal operation mode.

10. The laser mouse according to claim 9, wherein the second period is about 20 ms.

11. The laser mouse according to claim 1, wherein the light transmitter is a light emitting diode (LED).

12. The laser mouse according to claim 1, wherein the light receiver is a photo-transistor or a photo diode.

13. The laser mouse according to claim 1, wherein the laser mouse control unit comprises a laser source and a laser sensing device and when the processing unit determines the intensity of the signal is larger or equal to the threshold value, the processing unit controls the laser source to radiate the laser light such that the laser sensing device can detect the moving position of the laser mouse relative to the surface according to the part of the laser light reflected from the surface.

14. The laser mouse according to claim 13, wherein the laser source is a laser diode and the laser sensing device is a charge couple device (CCD) or a complementary metal oxide semiconductor (CMOS) light sensing device.

15. A method for controlling a laser mouse on a surface, the laser mouse comprising a laser mouse control unit, a light transmitter and a light receiver, the laser mouse control unit radiating a beam of laser light and detecting a moving position of the laser mouse relative to the surface according to a part of the laser light reflected from the surface, the light transmitter generating a beam of light, the light receiver receiving a part of the light reflected from the surface and accordingly generating a signal, the method comprising:
(a) setting a threshold value according to the signal; and
(b) determining whether intensity of the signal is smaller than the threshold value, and if yes, controlling the laser mouse control unit to stop radiating the laser light.

16. The method according to claim 15, wherein in the step (a), the threshold value is substantially and directly proportional to the intensity of the signal.

17. The method according to claim 16, wherein the step (a) comprises:
providing a preset value larger than 0 and smaller than 1;
obtaining the intensity of the signal; and
setting a multiplication of the intensity of the signal and the preset value to be the threshold value.

18. The method according to claim 17, wherein the preset value is substantially equal to 0.6.

19. The method according to claim 16, wherein the step (a) comprises:
providing a look-up table comprising a plurality of intensity ranges and selection values;
selecting one of the intensity ranges according to the intensity of the signal; and
setting the selection value corresponding to the selected intensity range to be the threshold value according to the look-up table.

20. The method according to claim 15, wherein the light transmitter is a light emitting diode (LED).

21. The method according to claim 14, wherein the light receiver is a photo-transistor or a photo diode.

22. The method according to claim 15, wherein the laser mouse control unit comprises a laser source and a laser sensing device, and the step (b) comprises:
when the intensity of the signal is larger than or equal to the threshold value, controlling the laser source to radiate the laser light such that the laser sensing device can detect the moving position of the laser mouse relative to the surface according to the part of laser light reflected from the surface.

23. The method according to claim 22, wherein the laser source is a laser diode and the laser sensing device is a charge couple device (CCD) or a complementary metal oxide semiconductor (CMOS) light sensing device.
